(19) United States
(12) Patent Application Publication
(10) Pub. No.: US 2010/0328762 A1
(43) Pub. Date: Dec. 30, 2010

(54) Radiation coating for silicon carbide components

(75) Inventor: William Goodman, Albuquerque, NM (US)

Correspondence Address: TREX ENTERPRISES CORP., 10455 PACIFIC COURT, SAN DIEGO, CA, 92121, US

(73) Assignee: Trex Enterprises Corp.

(21) Appl. No.: 12/799,599

(22) Filed: Apr. 27, 2010

Related U.S. Application Data
(60) Provisional application No. 61/214,786, filed on Apr. 27, 2009.

(51) Int. Cl. G02B 5/08

(52) U.S. Cl. 359/359

(57) ABSTRACT

A telescope mirror having a mirror substrate, a multi-layer thin film reflective coating of alternating layers of high and low index of refraction dielectric films and a thin metal film positioned between the mirror substrate and the multi-layer thin film reflective coating. In preferred embodiments the telescope is a satellite surveillance telescope and the mirror is designed to protect the telescope from blinding by a nuclear blast or proton radiation in the lower Van Allen belt.

### CROSS REFERENCE TO RELATED APPLICATIONS

The present invention claims the benefit of Provisional Application Serial No. 61/214,786 filed Apr. 27, 2009.

### FEDERALLY SPONSORED RESEARCH

The present invention was made in the course of performance of a contract with the Missile Defense Agency and the United States Government has rights in the invention.

### FIELD OF THE INVENTION

The present invention relates to silicon carbide components and in particular to radiation protected silicon carbide components.

### BACKGROUND OF THE INVENTION

Earth orbiting satellites are extensively used for surveillance both for defense and non-defense purposes. Some of the components of these satellites need protection against high energy radiation including nuclear radiation. Silicon carbide is an emerging technology that is being utilized for components such as mirrors in these satellites. Silicon carbide is a naturally stable material, but components made from silicon carbide can be damaged by radiation including radiation produced by a nuclear weapon or proton environment found in low earth orbit, i.e. the lower Van Allen belt.

Thus there is a need for special coatings to protect silicon carbide components, a significant number of operational temperatures cycles from 70-130 K, and optical performance across the 0.6-12 microns wavebands. The sensor wavebands of operation include requirements in the Visible (VIS, 0.4-0.7 μm), mid-wavelength infrared (MWIR, 3-5 μm), and the long-wavelength infrared (LWIR, 8-14 μm) portions of the spectrum.

### SUMMARY OF THE INVENTION

The present invention provides a protective coating for silicon carbide mirrors to protect telescopic system from high energy radiation, especially high energy radiation produced by thermonuclear explosions or radiation resulting from interactions with high energy protons sometimes encountered in low earth orbit. This invention is particularly useful for protection of satellite surveillance telescopes. These satellite surveillance telescopes if not adequately protected can be “blinded” by x radiation produced by a thermonuclear bomb exploded in the space between the satellite and its field of view on earth. There are two mechanisms for such intentional blinding that need to be prevented. The first mechanism is the destruction of the mirrors (typically a primary mirror and a secondary mirror) used to focus light on the imaging array of the telescope. The second mechanism for blinding the telescope is destruction of the imaging array by radiation reflected from or generated in the mirrors and focused by the mirrors on the imaging array. If not protected space telescope systems can also be degraded by high energy protons naturally found in low earth orbit.

The present invention is especially effective when utilized with silicon carbide mirrors, optical glass mirrors and silicon mirrors. Applicant utilizes a deterministic approach to provide specially designed coatings to protect the mirrors and the imaging array. The coatings are x-ray transparent thin films which allow the x-ray energy to transfer through the coating and to be deposited in the high-thermal diffusivity mirror substrate. The first layer adjacent to the substrate is a base metal layer such as a 0.5 micron thick layer of copper. The heated substrate then re-radiates in the infrared and this energy cannot pass back through the copper base metal layer and blind the sensor (since copper is an excellent infrared reflector with low emissivity, typically ˜0.03). The heat is effectively trapped in the bulk of the mirror substrate. The coating in preferred embodiments includes a high-purity Nb₂O₅/SiO₂ dielectric stack. These materials have relatively low Z (atomic number) and are thus also suitable for protecting against high energy protons. Applicants have performed space simulation testing of the preferred stack for a 10-year mission at 1600 km altitude and 60° inclination. Applicants have also tested the coating survival against a 300 krad(Si) dose of 63 MeV protons, simulating a 10-year mission life in low Earth orbit, and no change in the optical performance was recorded. Applicants have also tested the coating survival against a lethal dose of cold x-rays, simulating the effects of an exo-atmospheric nuclear explosion, and the coating demonstrated an extremely high damage threshold. This hardness to space and nuclear radiation is attributed to the high-density, and high-purity of the coating materials.

In a preferred embodiment the mirror substrate material is silicon carbide. Silicon carbide sample mirror substrates coated in accordance with the present invention were temperature cycled by immersing coated mirrors in liquid nitrogen and then allowing them to warm to ambient temperature a total of 20 cryo-cycles. The figure of the mirrors was measured both before and after the cryo-cycling and was found to be identical to within 1.3 nm RMS HeNe. The coated mirrors had an average figure error of 0.0414 waves HeNe peak-to-valley, which greatly exceeded a λ/10 requirement. The surface roughness of the mirror substrate exceeded the 10 Angstroms RMS goal by a factor of 10.

Preferred embodiments of the present invention include a telescope mirror having a mirror substrate, a multi-layer thin film reflective coating of a plurality of alternating layers of high and low index of refraction dielectric films and a metal film having a thickness of less than 1 micron positioned between the mirror substrate and the plurality of alternating layers of high and low index of refraction dielectric films. In preferred embodiments the mirror is a component of a satellite surveillance telescope and the multi-layer thin film reflective coating is adapted to transmit x-rays and reflect a broad spectrum of visible and infrared light. In other embodiments the multi-layer thin film reflective coating is adapted to transmit x-rays and reflect a narrow band spectrum of light within the visible and infrared light spectrum. Typically the multi-layer thin film reflective coating will contain of at least 5 layers but may contain more layers to provide narrow band filtering.

### BRIEF DESCRIPTION OF THE DRAWINGS

FIG. 1 is a listing of six layers of preferred protective coating for a silicon carbide space mirror.

### DETAILED DESCRIPTION OF PREFERRED EMBODIMENTS

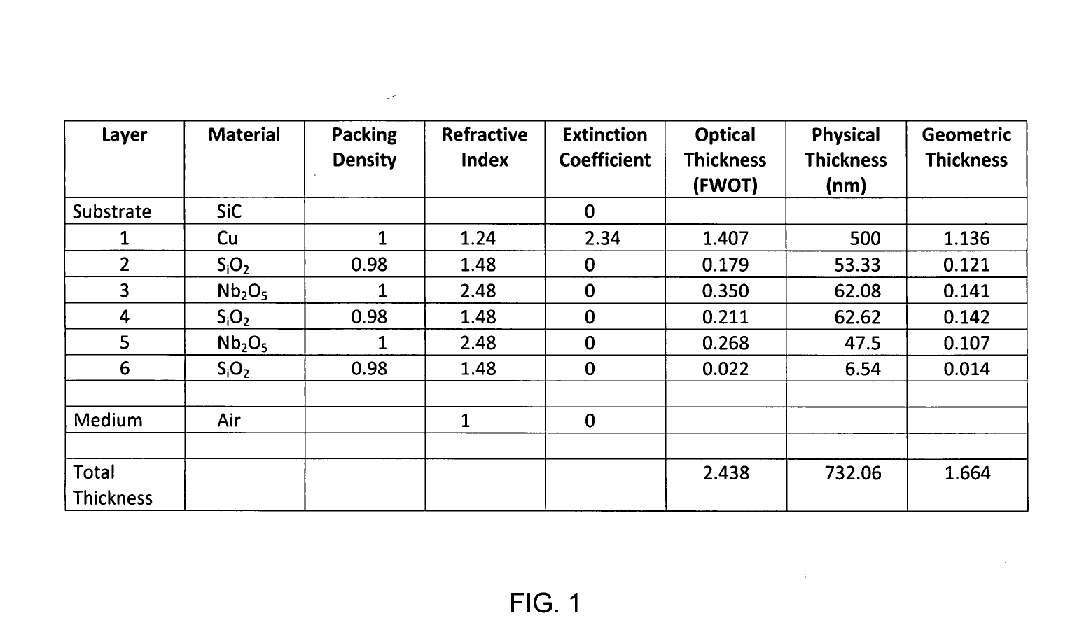

Preferred embodiments of the present invention include silicon carbide mirrors, primary and secondary mirrors coated with a space and nuclear survivable broad-band high reflectivity coating as described in FIG. 1. These mirror samples were prepared in a special chemical vapor deposition process in which tiny particles are injected into the reactor during the deposition process. This process is described in U.S. Pat. No. 5,154,862 which was assigned to Applicant's employer. The resulting silicon carbide is referred to as chemical vapor composite silicon carbide, or CVC-SiC®. As indicated in FIG. 1, the reflective coating includes a 0.5 micron layer of copper deposited directly on the silicon carbide substrate and alternating layers of silicon oxide (SiO₂) and niobium oxide (Nb₂O₅). This embodiment consists of three layers of silicon oxide and two layers of niobium oxide.

The coatings, including the 0.5 micron copper layer adjacent to the substrate, are x-ray transparent thin films which allow the x-ray energy to transfer through the coating and to be deposited in the high-thermal diffusivity mirror substrate. The heated substrate then re-radiates in the infrared but this energy cannot pass back through the copper base metal layer and blind the sensor (since copper is an excellent infrared reflector with low emissivity, typically ˜0.03). The heat is effectively trapped in the bulk of the mirror substrate and gradually cools by convection and radiation from other surfaces of the mirror substrate.

In a demonstration program Applicants have prepared small sample mirrors and extensively tested the sample mirrors to demonstrate the effectiveness of the present invention. The program included fabricating CVC-SiC® substrate coupons (piano), polishing the coupons to extremely low surface roughness and extremely high surface accuracy, and verifying the surface statistics of the substrates using Atomic Force Microscopy (AFM), Interferometry, Optical Profilometry and Bidirectional Reflectance Distribution Function (BRDF). The figure accuracy of the polished substrates was measured by Coastline Optics, with facilities in Camarillo, Calif., both before and after 20 cycles of cryo-cycling (defined as immersing the coupons in liquid nitrogen and then allowing them to return to ambient temperature). The space and nuclear survivable broad-band high reflectivity coating designed by Applicant was deposited by S-Systems Corporation, with facilities located in Air Force Research Laboratory at Kirtland Air Force Base, New Mexico via a near room temperature DC Magnetron Sputtering process. AFM and BRDF measurements were repeated after deposition of the coating. After coating the mirror figure accuracy was gain measured by Coastline Optics. The coated coupons were then cryo-cycled 20 times and their figures were re-measured.

Applicants also prepared eight 1.5-inch diameter coupons for nuclear simulation testing at the OMEGA facility in Rochester, N.Y. and the National Ignition Facility located in Lawrence Livermore National Laboratory, Livermore, Calif. These tests validated both the performance of the CVC SiC® substrates and resultant mirrors in simulated nuclear environments. Applicants also prepared eight 2.0-inch diameter coupons for high energy proton testing at the University of California, Davis.

### Coating Procedure

A preferred procedure is described below:

A copper with Nb₂O₅/SiO₂ dielectric over coat as described in FIG. 1 was applied to produce radiation hardened coatings on CVC-SiC® substrate coupons. The coating produces greater than 95% reflectivity from 0.4 microns to 25 microns. Up to twelve coupons 2 inches in diameter or smaller were coated. Prior to coating atomic force microscopy was performed on the as-polished samples. After coating atomic force microscopy, Interferometry, specular reflectivity and bidirectional reflectance distribution function were measured both before and after cryo-cycling (20 cycles) in liquid nitrogen. The metrology is performed on two of the coated samples.

AFM measurements were made on a 50 micron by 50 micron region, one measurement per sample. And BRDF measurements were made at 1.064 microns, 7.5 degrees angle of incidence P polarization. Reflectance measurements were made at 7 degrees angle of incidence from 0.4 microns to 2.5 microns and at 30 degrees angle of incidence from 2.5 microns to 25 microns.

Applicants delivered eight (8) polished 2-inch plano coupons to S-Systems Corporation, managing contractor on 2 Jul. 2009. The lot included coupons labeled A, B, C, and D which had been cryo-cycled and four (4) coupons not cryo-cycled. S-Systems performed AFM and BRDF measurements on Coupon D. AFM measurements were made on 1 micron by 1 micron, 10 micron by 10 micron, and 50 micron by 50 micron regions. The polished coupons had an average surface height of less than 3 nm with an RMS deviation of less than 0.8 nm.

S-Systems performed AFM and BRDF measurements on coated Coupon D. AFM measurements were made on 1 micron by 1 micron, 10 micron by 10 micron, and 50 micron by 50 micron regions. The “in spec” scratches that appeared on the as-polished coupons were no longer seen—the coating effectively covers them over. Rather, the surface of the coating had more of an “orange-peel” appearance at a nanometer scale. Progressing from the 1 square micron area histogram to the 100 square micron area histogram to the 2500 square micron histogram shows that the average surface height is on the order of 3.7 nm, with a deviation on the order 1.12 nm or less.

### Variations

The above described embodiment of the present invention is specifically directed at protecting space telescopic systems utilizing silicon carbide mirror substrates. Persons skilled in the art will recognize that many variations of the present invention are possible. The mirror substrate material could be a material other than silicon carbide, such as an optical glass or silicon. Techniques for designing thin film reflective layers are well known by persons skilled in telescope design. For example fewer or additional alternating layers of SiO₂ and Nb₂O₅ could be utilized. Other layer thicknesses could be examined using existing thin film design models. Other high and low index of refraction hard dielectric material could be substituted for the SiO₂ and Nb₂O₅. The copper film could be thinner or thicker but preferably should not be thicker than about 1 micron. It is important however that these layers be well matched to thermal expansion features of the substrate material. And it is important to include a thin infrared reflective layer such as the 0.5 micron thick copper layer, or equivalent, which will transmit x-rays and reflect infrared radiation in order to harmlessly trap the x-ray energy within the substrate mass. Therefore, the scope of the present invention should not be limited to the above described preferred embodiments, but by the appended claims and their legal equivalence.

What is claimed is:

1. A telescope mirror comprising:
A) a mirror substrate,
B) a multi-layer thin film reflective coating comprising a plurality of alternating layers of high and low index of refraction dielectric films,
C) a metal film having a thickness of less than 1 micron positioned between the mirror substrate and the plurality of alternating layers of high and low index of refraction dielectric films.

2. The telescope mirror as in claim 1 wherein the mirror is a component of a satellite surveillance telescope.

3. The telescope mirror as in claim 1 wherein the multi-layer thin film reflective coating is adapted to transmit x-rays and reflect abroad spectrum of visible and infrared light.

4. The telescope mirror as in claim 1 wherein the multi-layer thin film reflective coating is adapted to transmit x-rays and reflect a narrow band spectrum of light within the of visible and infrared light spectrum.

5. The telescope mirror as in claim 1 wherein the multi-layer thin film reflective coating is comprised of at least 5 layers.

6. The telescope mirror as in claim 1 wherein the multi-layer thin film reflective coating is comprised of three layers of low index of refraction film and two layers of high index of refraction film.

7. The telescope mirror as in claim 6 wherein the low index of refraction film is comprised of SiO2 and the high index of refraction film is Nb2O5.

8. The telescope mirror as in claim 1 wherein the metal film is copper.

9. The telescope mirror as in claim 1 wherein the metal film is silver.

10. The telescope mirror as in claim 2 wherein the mirror is a component of a telescope adapted to withstand an attempt to blind the telescope with a nuclear weapon.

11. The telescope mirror as in claim 2 wherein the mirror is a component of a telescope adapted to survive in encounters with high energy protons of the lower Van Allen belt.

12. The telescope mirror as in claim 1 wherein the mirror is a primary mirror.

13. The telescope mirror as in claim 1 wherein the mirror is a secondary mirror.
